(19) United States
(12) Patent Application Publication
(10) Pub. No.: US 2020/0270514 A1
(43) Pub. Date: Aug. 27, 2020

(54) WELL TREATMENT METHODS

(71) Applicant: Saudi Arabian Oil Company, Dhahran (SA)

(72) Inventors: Ahmed M. Gomaa, Khobar (SA); Mohammed A. Bataweel, Dhahran (SA); Mohammed Sayed, Houston, TX (US); Amy J. Cairns, Houston, TX (US); Aslan Bulekbay, Udhailiyah (SA); Khalid R. Alnoaimi, Khobar (SA)

(21) Appl. No.: 16/286,175

(22) Filed: Feb. 26, 2019

(51) Int. Cl. C09K 8/74; C09K 8/72; C09K 8/70; E21B 43/26; E21B 37/00

(52) U.S. Cl. CPC C09K 8/74; C09K 8/725; E21B 37/00; E21B 43/26; C09K 8/703

(57) ABSTRACT

Provided herein are compositions and methods for treating wells in geologic formations. The method involves introducing a first aqueous composition containing an organic acid into a well, introducing a second aqueous composition into the well, and forming a third composition useful for stimulating wells, fracturing geologic formations, and cleaning wells of filter cakes and other well blockages.

### TECHNICAL FIELD

This disclosure relates to methods of using organic acid compositions for chemically stimulating subterranean formations from which hydrocarbons can be recovered, and for chemically removing filter cakes and other obstructions that impede the production of hydrocarbons from subterranean formations.

### BACKGROUND

The development of multilateral wells and long-reach wells using extended-reach drilling (ERD) technology has become critical to maximizing hydrocarbon (liquid or gas) recovery for many oil and gas fields. ERD is the directional drilling of long horizontal wells to reach a larger area from one surface drilling location than would be reached by traditional vertical drilling. ERD is useful for maximizing well productivity and drainage capability.

One of the main challenges in multilateral/extended-reach oil and gas wells is wellbore cleaning to remove filter cakes and obstructions, and stimulating the well in hydraulic fracturing procedures to improve hydrocarbon flow from the formation into the well bore. Strong mineral acids are typically used to clean or stimulate wells. In many cases, it is difficult to provide the acid in the targeted sections or locations of the well after completely drilling the well. One reason for this difficulty is that the length of the well bore limits the reach of the coiled tubing used during the cleaning process. This is particularly a problem with multilateral wells and long-reach wells. Often, a high-efficiency diverter agent is needed to provide an acceptable distribution of the mineral acid in the targeted sections or locations of the well. The strong mineral acids used to clean or stimulate or hydraulic fracture wells are highly corrosive and damaging to pipes, tubing, and equipment, even when distribution of the mineral acids are targeted.

One method of stimulating or hydraulic fracturing multilateral/extended-reach wells is to stimulate or fracture each lateral drill volume immediately after drilling by using drilling pipes and equipment to provide a composition useful for stimulation, which is often a corrosive liquid such as an acid. This method allows the drilling pipes and equipment to remain in place in the well so that the drilling of the next lateral drill volume can commence without removal and reinsertion of equipment. However, this method is risky because compositions useful for stimulation or fracturing are usually highly corrosive and highly reactive to the drilling pipes and equipment in the well environment, thus potentially causing damage. The high acid-base reactivity and corrosiveness of many mineral acid-based compositions can also cause damage to the lateral drill volume during the drilling of the next lateral.

Thus, there is a need for a stimulation, fracturing, and cleaning treatment that is not highly corrosive and damaging to pipes, tubing, and equipment, yet provides effective stimulation and cleaning of filter cakes and other obstructions.

### SUMMARY

Provided in this disclosure are methods for chemically stimulating, acid hydraulic fracturing, and cleaning wells for extracting hydrocarbons from geologic formations. The disclosure relates to organic acid compositions and methods for treating wells to increase production and to improve efficiency. More specifically, the disclosure relates to stimulation and acid hydraulic fracturing of wells whereby the organic acid compositions are activated in situ to react with carbonates and other acid-sensitive geologic formations. The disclosure also relates to using organic acid compositions to clean wells, such as by removal of filter cake that may be formed in a well during a drilling and pumping operation. Such filter cakes can block sections of the well impeded well operations.

The methods provided in this disclosure involves applying a first composition comprising a high concentration of an organic acid (concentrated organic acid composition), such as an alkyl or aryl sulfonic acid, a phosphorous acid, an alkyl or aryl phosphonic acid, or a carboxylic acid, or combinations thereof into a target volume of the well. The first composition can contain various additives to aid its delivery to the target volume. The method further involves applying a second composition into the same target volume of the well. The second composition is a composition comprising water and optionally various additives to aid its delivery to the target volume. The combination of the first and second compositions inside the target volume of the well forms a third composition in situ inside the target well volume. The third composition comprises the organic acid of the first composition diluted to about 20 wt. % to about 40 wt. %.

In some embodiments of the method provided herein, the first composition is generally unreactive or minimally reactive with the geologic formation or a filter cake located in the well, the second composition can be reactive or unreactive with the geologic formation or a filter cake located in the well, while the third composition, which is an in situ generated mixture of the first and second compositions, is reactive with the geologic formation or the filter cake.

In some embodiments of the method provided herein, the organic acid is an alkyl sulfonic acid, preferably methanesulfonic acid.

In some embodiments of the method provided herein, the first composition comprises about 68 wt. % to about 72 wt. % methanesulfonic acid.

In some embodiments of the method provided herein, the third composition comprises about 20 wt. % to about 40 wt. % methanesulfonic acid.

In some embodiments of the method provided herein, the well has one or more lateral sections, and is a multilateral well or an extended reach well.

In some embodiments of the method provided herein, the compositions are applied to a section of the well containing a filter cake that is causing blockage.

In some embodiments of the method provided herein, a chemical or mechanical diverter is applied to the well before applying the compositions.

In some embodiments of the method provided herein, at least one lateral section is plugged with a viscous fluid, a gel, or a solid.

In some embodiments of the method provided herein, the second (diluent) composition contains mineral acid, organic acid, a metal chelating agent, a polymer, a gelling agent, an emulsifier, a foaming agent, or a defoaming agent, or combinations thereof.

In some embodiments of the method provided herein, the diluent compositions has a hydrochloric acid concentration of about 0.1 wt. % to about 32 wt. %.

In some embodiments of the method provided herein, the diluent composition has a formic acid concentration of about 0.1 wt. % to about 12 wt. %.

In some embodiments of the method provided herein, the diluent composition has a acetic acid concentration of about 0.1 wt. % to about 20 wt. %.

In some embodiments of the method provided herein, the diluent composition contains carboxylic acid selected from the group consisting of monocarboxylic acid, dicarboxylic acid, tricarboxylic acid, and tetracarboxylic acid, or combinations thereof.

In some embodiments of the method provided herein, the alkylsulfonic acid is methanesulfonic acid having a concentration in the combined first and diluent composition (third composition) of about 0.1 wt. % to about 20 wt. %.

In some embodiments of the method provided herein, the diluent compositions contain metal chelating agent selected from the group consisting of EDTA, MGDA, GLDA, and HEDTA, or combinations thereof, and the metal chelating agent has a concentration of about 0.1 wt. % to about 40 wt. % in the second composition.

In some embodiments of the method provided herein, the first composition is a gel, and comprises one or more of a linear polymer, a cross-linked polymer, or a viscoelastic surfactant.

In some embodiments of the method provided herein, the first composition is an emulsion, and comprises a diesel fuel, mineral oil, crude oil, hydrocarbon, or an organic solvent.

In some embodiments of the method provided herein, the first composition is a foam, and comprises a gas. The gas can be selected from one or more of air, nitrogen, carbon dioxide, methane, ethane, propane, natural gas, oxygen, or hydrogen.

In some embodiments of the method provided herein, a gas or mixture of gases is applied to the well simultaneously with applying the concentrated organic acid compositions.

In some embodiments of the method provided herein, the geologic formation is a carbonate, a sandstone, or a shale formation. When the geologic formation is a carbonate formation, and after forming the third composition in the well in such a formation, wormholes develop in the carbonate formation from reaction of the acid in the third composition with the carbonate formation, thereby stimulating the well. When the geologic formation is a sandstone or shale formation, and after forming the third composition in the well in such a formation, permeability of the well is enhanced from reaction of the acid in the third composition with acid-soluble species within the sandstone or shale formation, thereby stimulating the well.

The methods provided in this disclosure of stimulating, acid hydraulic fracturing, and cleaning wells using organic acids are advantageous for a number of reasons over conventional methods of using concentrated mineral acids for stimulating and cleaning wells. In the conventional methods, the concentrated mineral acids are highly corrosive and reactive to piping, tubing, pumps, valves, mechanical diverters, and other equipment, thus causing damage, shortening the usable life of equipment, and increasing the frequency of service and replacement disruptions. In some embodiments, the methods provided in this disclosure avoid bringing piping, tubing, pumps, valves, and other equipment in contact with as much or any highly corrosive acidic compositions, such as certain mineral acid compositions (e.g. HCl). Instead, piping, tubing, pumps, valves, and other high value equipment that are outside the treatment zone are exposed to a smaller amount of corrosive acid compositions. The organic acid compositions of the methods provided in this disclosure become activated and increase corrosiveness and reactivity to effective levels in situ upon addition of a diluent solution to the targeted treatment zones within the wells. Moreover, the methods provided in this disclosure allow inclusion of additives in the concentrated organic acid compositions to aid the placement of the compositions in desired volumes inside the wells. These additives include viscosity modifiers. Still further, the methods provided in this disclosure allow control over the timing of the stimulation and cleaning activities because the effective stimulation or cleaning compositions are formed in situ only upon addition of a diluent composition. By contrast, conventional use of concentrated mineral acids for the same purposes require injection of the acid concentrate at the effective strength, thus there is no option of delayed activation of the stimulation or cleaning process. Yet, in some embodiments, another advantage of the methods provided in this disclosure is the convenience and safety of not having to store and transport highly reactive concentrated compositions of mineral acids. Instead, unreactive or less reactive concentrated organic acid compositions are transported and stored. Reactive organic acid compositions are later formed in situ downhole in the subterranean formation.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1D show limestone core samples before and after treatment with methanesulfonic acid (“MSA’) compositions. FIG. 1A shows the untreated limestone core sample. FIG. 1B shows the limestone core sample after treatment with an aqueous 70 wt. % MSA solution. FIG. 1C shows the limestone core sample after treatment with an aqueous 35 wt. % MSA solution. FIG. 1D shows the limestone core sample after treatment with in-situ generated aqueous 35 wt. % MSA solution.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

The terms “unreactive,” “non-reactive,” and “non-corrosive” as used in this disclosure to describe the organic acid compositions refer to levels of acid-base reactivity that do not have substantial damaging effect on equipment, piping, tubing, and other materials in a well over the period of time, for example, a few hours to a few days, during which drilling, stimulating, and cleaning processes can take place. The terms “unreactive” and “non-reactive” in this context also refer to levels of acid-base reactivity that do not have substantial effect on carbonate and other geologic formations and on acid-reactive filter cakes over the period of time, for example, a few hours to a few days, during which drilling, stimulating, and cleaning processes can take place. In some embodiments, an acid composition is considered unreactive for the purposes of this disclosure if a homogenous Indiana limestone core having a diameter of 1.5″ and a length of 0.5″ immersed in the acid composition for 5 minutes results in a weight loss of less than 2% of the core.

The terms “reactive” and “corrosive” as used in this disclosure to describe the organic acid composition refer to reactivity and corrosiveness to cause substantial damaging effect on equipment, piping, tubing, and other materials in a well over the period of time, for example, a few hours to a few days, during which drilling, stimulating, and cleaning processes can take place. The terms “reactive” and “corrosive” in this context also refer to acid-base reactivity with carbonate and other geologic formations and on acid-reactive filter cakes such that stimulation and cleaning can occur over the period of time, for example, a few hours to a few days, during which drilling, stimulating, and cleaning processes can take place. For example, an acid composition is considered reactive for the purposes of this disclosure if a homogenous Indiana limestone core having a diameter of 1.5″ and a length of 0.5″ immersed in the acid composition for 5 minutes results in a weight loss of greater than 10% of the core.

The term “alkyl” as used herein refers to straight chain, branched alkyl groups and cycloalkyl groups having from 1 to about 40 carbon atoms, 1 to about 20 carbon atoms, 1 to about 12 carbons or, in some embodiments, from 1 to about 8 carbon atoms. Examples of straight chain alkyl groups include those with from 1 to about 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “aryl” as used herein refers to cyclic aromatic hydrocarbons that may or may not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

As used herein, the term “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

There are practical limits to accurately measuring weights and volume in an oil field both above and below ground. In particular, underground measurements of drill volume and other parameters can have substantial error. And such errors would affect the calculation of concentration. As such, the use of the term “about” in this disclosure would be understood by a person in this field to allow a reasonable deviation of plus and minus “5” for the lowest significant digit, except when doing so would give a negative value. For example, about 65% means 60%-70%. For another example, about 0.5% means 0.0% to 1.0%. And for a third example, about 0.1% means 0.0% to 0.6%.

### Methods for Treating Wells in Geologic Formations

Provided in this disclosure are well stimulation, acid hydraulic fracturing, and cleaning treatment methods. In some embodiments, the methods are not as damaging to pipes, tubing, and well equipment as known well treatment methods. Also, provided in this disclosure are methods of treating a well that can stimulate release of hydrocarbons in multilateral and extended-reach wells while reducing damage to the drilling pipes and equipment. Further provided in this disclosure are methods of treating a well that can decrease the risk of damage to a stimulated or fractured lateral drill volume during the drilling of subsequent lateral drill volumes. Additionally provided in this disclosure are methods for treating geologic formations to stimulate the formation to increase oil or gas production. In some embodiments, the methods increase crude oil production compared to wells that are not treated by the described methods. This disclosure also provides methods for cleaning and removing blockages inside wells. In some embodiments, the blockages are caused by filter cakes.

Provided in this disclosure are methods for treating a well in a geologic formation that include introducing to the well a first composition that contains an acid, and introducing to the well a second composition that contains water, where the first composition and second composition combine to form a third composition that has a lower concentration of acid than the first composition. In some embodiments, the methods include introducing a first composition that includes an organic acid to a treatment location in a well in a geologic formation, introducing a second composition that is an aqueous diluent to the same treatment location in the well, and forming a third composition in situ. In some embodiments, the first composition is unreactive with the formation. In some embodiments, the third composition is reactive with the formation. In some embodiments, the third composition reacts with the formation to create worm holes and/or increase permeability. In some embodiments, reaction of the third composition with the formation stimulates or fractures the formation.

In the methods provided in this disclosure, a first composition is introduced or applied to the well. In some embodiments, the first composition is introduced or applied to the well by injecting, flowing, displacing, or pumping the composition into the well. In some embodiments, the first composition is introduced into a targeted drill volume or zone of the well by injection methods and apparatuses. In some embodiments, diverters are used to target specific volumes or zones of the well. In some embodiments, the first composition is unreactive or nonreactive with the well, pipes, tubing, equipment, geologic formation, and other objects and materials that it contacts. In some embodiments, the first composition is noncorrosive to the well, pipes, tubing, equipment, geologic formation, and other objects and materials that it contacts.

In the methods provided in this disclosure, a second composition is introduced or applied to the well. In some embodiments, the second composition is introduced or applied to the well by injecting, flowing, displacing, or pumping the composition into the well. In some embodiments, the second composition is introduced into desired targeted drill volume or zone of the well. In some embodiments, the second composition is introduced by injection methods and apparatuses. In some embodiments, the second composition is introduced to the same or overlapping drill volume or zone of a well as the first composition.

In the methods provided in this disclosure, a third composition is formed in situ by the combination or mixing of the first and the second compositions in the well in the geologic formation. In some embodiments, the third composition is reactive with the formation. In some embodiments, the third composition is corrosive to the formation. In some embodiments, the third composition is useful for stimulating, fracturing, and cleaning the well or removing filter cakes. In some embodiments, the third composition dissolves carbonate and other acid soluble materials. In some embodiments, the well is in a carbonate or limestone geologic formation. In some embodiments, when the well is in a carbonate or limestone geologic formation, the third composition produces wormholes in the formation. In some embodiments, the wormholes contribute to increased accessibility or flow of the hydrocarbons in the formation. In other embodiments, the well is in a sandstone or shale formation. In some embodiments, when the well is in a sandstone or shale formation, stimulation or fracturing occurs by reaction of the third composition with acid-soluble species within the formation. In some embodiments, fractures and continuous pores develop from stimulation or fracturing treatment using the third composition.

In some embodiments of the methods provided in this disclosure, a first composition containing an organic acid is injected into a drill volume (e.g., a lateral section of a multilateral well) where stimulation or fracturing is desired. In some embodiments, the first composition contains about 65-72 wt. % of an organic acid. In some embodiments, the organic acid is methanesulfonic acid. In some embodiments, after the introduction of the first composition to the target drill volume, other well drilling and maintenance activities can take place without appreciable reaction between the first composition and the drill volume where the first composition was injected. In some embodiments, immediately after introduction of the first composition or after a delay, a second composition containing water is injected into the same drill volume. In some embodiments, the second composition is injected to dilute the organic acid concentration inside that drill volume. In some embodiments, the organic acid concentration of the first composition is diluted from about 60-72 wt. % to about 20-40 wt. % by the second composition to form a third composition. In some embodiments, the dilution of the first composition by the second composition to form the third composition occurs in situ inside the drill volume. In some embodiments, the third composition is reactive with the geologic formation and with filter cakes.

In some embodiments, the first and second compositions are applied to multilateral wells, extended reach wells, or multi-lateral/extended reach wells. In some embodiments, the compositions are introduced to a single lateral section or to multiple lateral sections. In some embodiments, introduction of a composition to multiple lateral sections takes place simultaneously. In some embodiments, introduction of a composition to multiple lateral sections takes place sequentially. In some embodiments, diverters, plugs, valves, and other fluid directing devices are used to control and direct a composition to a particular lateral section or sections. In some embodiments, diverters, plugs, valves, and other fluid directing means are used to control the timing of when a composition is introduced to a certain lateral section. In some embodiments, a first composition can be introduced to two or more lateral sections before a second composition is introduced to the same two or more lateral sections. In some embodiments, a first composition and a second composition are introduced to a first lateral section, followed by introduction of a first composition and a second composition to the next lateral section.

### Organic Acid Compositions

In the methods described in this disclosure, the first composition is an organic acid composition. Without wishing to be bound by any theory, the reactivity and corrosiveness of some organic acids, such sulfonic acids, carboxylic acids, phosphorous acid, and phosphonic acids, can be inversely dependent on the acid concentration over a certain range. Within this inverse concentration-reactivity range, acid-base reactivity can be higher at lower concentrations of the acid and lower at higher concentrations of the acid. In some embodiments, the methods provided in this disclosure take advantage of the inverse concentration-reactivity of these organic acids, for example, for well stimulation, acid fracturing, and filter cake removal applications.

In the methods described in this disclosure, the first composition includes an organic acid. In some embodiments, the organic acid is selected from among a sulfonic acid, carboxylic acid, a phosphorous acid, a phosphonic acid, and combinations thereof. Further, a sulfonic acid is selected from mono-, di-, tri-, tetra- penta-, hexa- and poly-sulfonic acids. A phosphorous acid is selected from mono-, di-, tri-, tetra- penta-, hexa- and poly-carboxylic acids. A phosphonic acid is selected from mono-, di-, tri-, tetra- penta-, hexa- and polyprotic phosphonic acids. In some embodiments, the organic acid is selected from an acid having two or more different types of organic acid functional groups, such as for example a diprotic acid having a carboxylic acid functional group and a sulfonic acid functional group.

In some embodiments, the organic acid is a sulfonic acid. As used herein, a sulfonic acid refers to a member of the class of organosulfur compounds with the general formula R—S(═O)₂—OH, where R is an organic alkyl or aryl group with or without heteroatom substitution and the S(═O)₂—OH group is a sulfonyl hydroxide. Many sulfonic acids are soluble in water and exhibit similar inverse concentration reactivity properties across certain concentration ranges. In some embodiments, the sulfonic acid is a strong alkylsulfonic acid or an arylsulfonic acid.

In some embodiments, the sulfonic acid is an alkylsulfonic acid. Examples of alkylsulfonic acids include, but are not limited to, methanesulfonic acid, ethane sulfonic acid, propane sulfonic acid, butane sulfonic acid, pentane sulfonic acid, hexane sulfonic acid, heptane sulfonic acid, octane sulfonic acid, nonane sulfonic acid, and decane sulfonic acid. Suitable alkylsulfonic acids include those with linear or branched alkyl chains, as well as heteroatom substituted linear or branched alkyl chains, and aromatic ring or group substituted linear or branched alkyl chains. In some embodiments, the alkylsulfonic acid is methanesulfonic acid.

In some embodiments, the sulfonic acid is an arylsulfonic acid. Examples of arylsulfonic acids include, but are not limited to, benzensulfonic acid, p-toluenesulfonic acid, 4-ethylbenzene sulfonic acid, and dodecylbenzenesulfonic acid. Suitable arylsulfonic acids include those with substituents on the aromatic group that are adjacent to the sulfonate sulfur atom.

In some embodiments, the sulfonic acid is methanesulfonic acid (MSA). MSA is a strong organic acid and therefore has the capacity to dissolve a wide range of metal salts. Some metal salts can be dissolved at higher concentrations in MSA solutions than in mineral acids such as hydrochloric or sulfuric acid. In some embodiments, MSA has advantages over other acid systems for well treatment applications. For example, from a safety perspective MSA is more desirable to handle in the field than traditionally used inorganic acids because it is odorless, has a low vapor pressure and therefore does not give off toxic fumes and it is readily biodegradable. Moreover, it is non-oxidizing and exhibits high thermal stability.

In some embodiments, the organic acid is a carboxylic acid. In some embodiments, the organic acid is a polycarboxylic acid. For example, in some embodiments, the organic acid is an acid comprising at least two, three, four, five, six, seven, eight, nine, or ten carboxylic acids. Exemplary such carboxylic acids are well known to those of skill in the chemical arts and are contemplated for use in compositions and methods described in this application. Exemplary organic acids include, but are not limited to, formic acid, acetic acid, alkyl carboxylic acids, aryl carboxylic acids, lactic acid, glycolic acid, malonic acid, fumaric acid, citric acid, tartaric acid, chloroacetic acid, dichloroacetic acid, trichloroacetic acid, fluoroacetic acid, difluoroacetic acid, trifluoroacetic acid, glutamic acid diacetic acid, methylglycindiacetic acid, 4,5-imidazoledicarboxylic acid. Exemplary organic acids can also include, but are not limited to, 1,2-cyclohexanediaminetetraacetic acid (CDTA), diethylenetriamineepentaacetic acid (DTPA), ethylenediamineteraacetic acid (EDTA), hydroxyaminocarboxylic acid (HACA), HEDTA (N-hydroxyethyl-ethylenediamine-triacetic acid), hydroxyethyleneiminodiacetate (HEIDA), N,N′-bis(carboxymethyl)glycine (NTA), tetraammonium EDTA, and derivatives and mixtures thereof.

In some embodiments, the organic acid is a phosphorous acid. Phosphorous acid is the compound with the formula H—P═O(—OH)₂. Phosphorous acid is a acid with a pKa in the range 1.26-1.3.

In some embodiments, the organic acid is a phosphonic acid. In some embodiments, the phosphonic acid is selected from an alkylphosphonic acid and an arylphosphonic acid. As used herein, a phosphonic acid is a compound with the formula R—P═O(—OH)₂, where the R group is an alkyl group or an aryl group with or without heteroatoms. Alkylphosphonic and arylphosphonic acids generally have pKas in the range of 0 to 2.

In some embodiments, the first composition contains more than one type of organic acid. In some embodiments, the first composition contains mixtures of sulfonic acids, carboxylic acids, and phosphonic acids with different alkyl and aryl substitutions. In some embodiments, the organic acid is heterofunctional having two or more different functional groups selected from sulfonic acids, carboxylic acids, and phosphonic acids.

In some embodiments, the second acid or acid-generating compound is selected from the group consisting of any esters and formates that are water soluble or partially water soluble. Exemplary acid-generating compounds include lactic acid derivatives, methyl lactate, ethyl lactate, propyl lactate, and butyl lactate. In some embodiments, the acid-generating compound is a formate ester including, but are not limited to, ethylene glycol monoformate, ethylene glycol diformate, diethylene glycol diformate, glyceryl monoformate, glyceryl diformate, glyceryl triformate, triethylene glycol diformate, and formate esters of pentaerythritol. In certain embodiments, the acid-generating compound is ethylene glycol monoformate or diethylene glycol diformate. In some embodiments, the acid-generating compound is a nitrile-containing compound. In some embodiments, the acid generating compound is an ester, for instance, polyesters of glycerol including, but not limited to, tripropionin (a triester of propionic acid and glycerol), trilactin, and esters of acetic acid and glycerol such as monoacetin, diacetin, and triacetin. In some embodiments, the acid-generating compound(s) may include esters, aliphatic polyesters, poly(lactides), poly(glycolides, poly(E-caprolactones), poly(hydroxybutyrates), poly(anhydrides), aliphatic polycarbonates, poly(amino acids), and polyphosphazenes, or copolymers thereof, or derivatives and combinations are also suitable. In some embodiments, the second acid or acid-generating compound comprises esters, aliphatic polyesters, orthoesters, poly(orthoesters), poly(lactides), poly(glycolides), poly(c-caprolactones), poly(hydroxybutyrates), poly(anhydrides), ethylene glycol monoformate, ethylene glycol diformate, diethylene glycol diformate, glyceryl monoformate, glyceryl diformate, glyceryl triformate, triethylene glycol diformate, formate esters of pentaerythritol, or any combination thereof. Without wishing to be bound by any theory, it is believed that the differences in solubility, pKa, and other physico-chemical properties of various organic acids allow fine-tuning of the combinations and ranges of concentrations over which inverse-reactivity relationship is achieved, and over which the acid compositions can be used for well stimulation, acid fracturing, and cleaning. In some embodiments, an organic acid, or mixtures of organic acids, with acid-base reactivity that is higher at lower concentrations of the acid and lower at higher concentrations of the acid can be used in the methods provided in this disclosure. The methods and compositions in this disclosure are thus not limited to only the organic acids specifically described.

In the methods described, the first composition includes an organic acid at a concentration where the first composition is minimally reactive or nonreactive with the geologic formation. In the methods described, the first composition is nonreactive with well piping and equipment. In some embodiments, the first composition, when introduced into a well, does not appreciably stimulate geologic formation over the course of several hours to several days and up to about one month. In some embodiments, the first composition, when introduced into a well, does not appreciably cause corrosion of pipes, tubing, and well equipment over the course of several hours to several days and up to about one month.

In some embodiments, the first composition includes an organic acid in an amount of about 65% to about 99.5% by weight of the first composition. For example, the organic acid can be about 65% to about 99.5% by weight of the first composition, such as about 65% to about 95%, about 65% to about 90%, about 65% to about 85%, about 65% to about 80%, about 65% to about 75%, about 65% to about 70%, about 70% to about 99.5%, about 70% to about 95%, about 70% to about 90%, about 70% to about 85%, about 70% to about 80%, about 70% to about 75%, about 75% to about 99.5%, about 75% to about 95%, about 75% to about 90%, about 75% to about 85%, about 75% to about 80%, about 80% to about 99.5%, about 80% to about 95%, about 80% to about 90%, about 80% to about 85%, about 85% to about 99.5%, about 85% to about 95%, about 85% to about 90%, about 90% to about 99.5%, about 90% to about 95%, or about 95% to about 99.5% by weight of the first composition. In some embodiments, the first composition includes an organic acid in an amount about 65%, 70%, 75%, 80%, 85%, 90%, 95%, 99%, or about 99.5% by weight of the first composition. In some embodiments, the first composition includes an organic acid in an amount of about 70% by weight of the first composition. In some embodiments, the organic acid is MSA.

In some embodiments, the first composition includes MSA in an amount of about 70% by weight of the first composition. In some embodiments, at that concentration, the first composition is non-reactive with well piping and equipment. In some embodiments, at that concentration, the first composition is minimally reactive or nonreactive with geologic formations. In some embodiments, the geologic formations are carbonate, sandstone, or shale formations.

In some embodiments, the first composition includes additional components or additives. In some embodiments, the type and quantity of additives in the first composition can depend on one or more characteristics of the geologic formation, such as the type of geologic formation (for example, carbonate, sandstone, or shale), as well as the density, depth, and other characteristics of the well.

The additives to the first composition can be any substance that, for example, does not adversely affect hydrocarbon production, or can aid the delivery of the first composition to the targeted location in the well. In some embodiments, the first composition includes additives selected from among metal chelating agents, linear polymers, crosslinked polymers, gelling agents, emulsifiers, foaming agents, defoaming agents, scale inhibitors, biocides or disinfectants, lubricants, friction reducing agents, corrosion inhibitors, iron control/stabilizing agents, and other additives that can improve stimulation or fracturing of the formation, reduce corrosive effects on equipment, piping, and tubing, and improve the delivery of the compositions into the target well volume. In some embodiments, these additives are included in the first composition at concentrations of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the additive is a polymer. In some embodiments, the polymer acts as a viscosity modifier. In some embodiments, the additive is a gelling agent. Examples of suitable polymers and gelling agents include, but are not limited to, xanthan gum, guar gum, hydroxypropyl guar (HPG), carboxymethyl HPG (CMHPG), hydroxyethyl cellulose (HEC), polyacetic acid, polyacrylamide, as well as crosslinked and copolymers of the above. In some embodiments, the polymers and gelling agents are included in the first composition at concentrations of about 0.1 wt. % to about 30 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 30 wt. %, or about 10 wt. % to about 30 wt. %.

In some embodiments, the first composition includes a metal chelating agent. Examples of suitable metal chelating agents that can be added to the first composition include, but are not limited to, EDTA (ethylenediamine tetraacetic acid), HEDTA (hydroxyethylenediamine triacetic acid), NTA (nitriolotriacetic acid), citric acid, MGDA (methylglycindiacetic acid), GLDA (N,N-Dicarboxymethyl glutamic acid tetrasodium salt), and HEDTA (N-(hydroxyethyl)-ethylenediaminetriacetic acid), ethanol-diglycinic acid (EDG), L-glutamic acid N,N-diacetic acid, tetra sodium salt (GLDA), sodium hexametaphosphate (SHMP). In some embodiments, the chelating agents are included in the first composition at concentrations of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the first composition includes a foaming agent. Examples of suitable foaming agents that can be added to the first composition include, but are not limited to, gases such as air, nitrogen, carbon dioxide, methane, ethane, propane, natural gas, oxygen, or hydrogen. In some embodiments, the foaming agent is injected into the first composition to create a first composition with foam consistency. In some embodiments, injection of the foaming agent into the first composition occurs above ground. In some embodiments, injection of the foaming agents into the second composition occurs in the well. In some embodiments, the foaming agent is co-injected into the well along with the first composition to form a first composition with foam consistency inside the well.

In some embodiments, the first composition includes a defoaming agent. Examples of suitable defoaming agents that can be added to the first composition include, but are not limited to, mineral oil, diesel, gasoline, white oil, fatty alcohols, fatty esters, lauryl sulfate, polyalkylsiloxanes, ethylene or propylene glycol and their polymers, alkyl polyacrylates, silica powders, and alkyl alcohols such as isopropanol. In some embodiments, the defoaming agent reduces the amount of foaming that occurs during introduction of the first composition into the well. In some embodiments, the defoaming agent are included in the first composition at a concentration of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the first composition includes an emulsifier. Examples of suitable emulsifiers that can be added to the first composition include, but are not limited to diesel, gasoline, oil, mineral oil, white oil, lecithin, fatty alcohols, and fatty esters. In some embodiments, the emulsifier aids in the introduction of the first composition in the target well volume. When water-insoluble additives such as diesel and oil are in the first composition, water soluble species in the composition can remain in the aqueous fraction of the composition. When there are aqueous and non-aqueous fractions within a composition, the weight percentage of the water-soluble species is calculated based on the weight of the aqueous fraction that includes all water-soluble species dissolved in the aqueous phase. Water insoluble species such as diesel and oil are excluded from the solution weight, even when they are present as components of an emulsion. In some embodiments, an emulsifier is included in the first composition at a concentration of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

### Aqueous Compositions

In the methods described in this disclosure, the second composition is an aqueous solution containing water. The methods described include introducing to a well in a geologic formation containing the first composition the second composition that includes water (aqueous composition). In some embodiments, the second composition is used to dilute the first composition containing an organic acid.

The water used in the aqueous composition can be any type of water. In some embodiments, the water is seawater, brine, slick water, or produced water.

In some embodiments, the second composition includes additional components or additives. In some embodiments, the type and quantity of additives in the second composition depends on one or more characteristics of the geologic formation such as the type of geologic formation (for example, carbonate, sandstone, or shale), as well as the density, depth, and other characteristics of the well.

The additives to the second composition can be any substance that, for example, does not adversely affect hydrocarbon production, or can aid the delivery of the second composition to the targeted location in the well. In some embodiments, the second composition includes additives selected from among mineral or organic acids, metal chelating agents, linear polymers, crosslinked polymers, gelling agents, emulsifiers, foaming agents, defoaming agents, scale inhibitors, biocides or disinfectants, lubricants, friction reducing agents, corrosion inhibitors, iron control/stabilizing agents, and other additives that can improve stimulation or fracturing of the formation, reduce corrosive effects on equipment, piping, and tubing, and improve the delivery of the compositions into the target well volume. In some embodiments, these additives are included in the second composition at concentrations of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the additional component is an acid or combination of acids. For example, the second composition can include an acid selected from among hydrochloric acid, carboxylic acids, heterofunctional acids, alkylsulfonic acids, arylsulfonic acids, phosphorous acid, and phosphonic acids. In some embodiments, the carboxylic acids are carboxylic acids.

In some embodiments, the second composition includes a carboxylic acid. In some embodiments, the carboxylic acid is a monocarboxylic acid. Examples of monocarboxylic acids include, but are not limited to, formic acid, acetic acid, propionic acid, butyric acid, valeric acid, caproic acid, lauric acid, and palmitic acid. In some embodiments, the carboxylic acid is a dicarboxylic acid. Examples of dicarboxylic acids include, but are not limited to, oxalic acid, malonic acid, succinic acid, glutaric acid, and adipic acid. In some embodiments, the carboxylic acid is a tricarboxylic acid. Examples of tricarboxylic acids include, but are not limited to, citric acid, trimesic acid, isocitric acid, aconitic acid, and propane-1,2,3-tricarboxylic acid. In some embodiments, the carboxylic acid is a tetracarboxylic acid. Examples of tetracarboxylic acids include EDTA (ethylenediaminetetraacetic acid) and GLDA ((N,N-Dicarboxymethyl glutamic acid). Examples of pentacarboxylic acid include propane-1,1,1,2,2-pentacarboxylic acid and Cyclohexane-1,1,2,2,3-pentacarboxylic acid. Exemplary carboxylic acids can also include, but are not limited to, 1,2-cyclohexanediaminetetraacetic acid (CDTA), diethylenetriamineepentaacetic acid (DTPA), ethylenediamineteraacetic acid (EDTA), hydroxyaminocarboxylic acid (HACA), HEDTA (N-hydroxyethyl-ethylenediamine-triacetic acid), hydroxyethyleneiminodiacetate (HEIDA), N,N′-bis(carboxymethyl)glycine (NTA), tetraammonium EDTA, and derivatives and mixtures thereof. Various other carboxylic acids are well known to those of skill in the chemical arts and are contemplated for use in methods described in this application.

In some embodiments, the second composition contains hydrochloric acid. In some embodiments, the hydrochloric acid concentration is between about 0.1 wt. % and about 32 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 20 wt. %, or about 10 wt. % to about 32 wt. %.

In some embodiments, the second composition contains formic acid. In some embodiments, the formic acid concentration is between about 0.1 wt. % to about 12 wt. %. In some embodiments, the second composition contains acetic acid. In some embodiments, the acetic acid concentration is between about 0.1 wt. % to about 20 wt. %. In some embodiments, the second composition contains a sulfonic acid. In some embodiments, the sulfonic acid concentration is between about 0.1 wt. % to about 20 wt. % such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 20 wt. %, or about 10 wt. % to about 20 wt. %.

In some embodiments, the additive is a polymer. In some embodiments, the polymer acts as a viscosity modifier. In some embodiments, the additive is a gelling agent. Examples of suitable polymers and gelling agents include, but are not limited to xanthan gum, guar gum, hydroxypropyl guar (HPG), carboxymethyl HPG (CMHPG), hydroxyethyl cellulose (HEC), polyacetic acid, polyacrylamide, as well as crosslinked and copolymers of the above. In some embodiments, the polymers and gelling agents are included in the second composition at concentrations of about 0.1 wt. % to about 30 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 30 wt. %, or about 10 wt. % to about 30 wt. %. In some embodiments, the gelling agent is borax. In some embodiments, the borax is dissolved in about 15% to about 20% by weight HCl before being added to the second composition. In some embodiments, the borax in the second composition solution reacts with metal ions contained within the subterranean formation to form a gel. In some embodiments, the metal ions are calcium or magnesium.

In some embodiments, the second composition includes a metal chelating agent. Examples of suitable metal chelating agents that can be added to the second composition include, but are not limited to, EDTA (ethylenediamine tetraacetic acid), HEDTA (hydroxyethylenediamine triacetic acid), NTA (nitriolotriacetic acid), citric acid, MGDA (methylglycindiacetic acid), GLDA (N,N-Dicarboxymethyl glutamic acid tetrasodium salt), and HEDTA (N-(hydroxyethyl)-ethylenediaminetriacetic acid), ethanol-diglycinic acid (EDG), L-glutamic acid N,N-diacetic acid, tetra sodium salt (GLDA), sodium hexametaphosphate (SHMP). In some embodiments, the chelating agents are included in the second composition at concentrations of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the second composition includes a foaming agent. Examples of suitable foaming agents that can be added to the second composition include, but are not limited to, gases such as air, nitrogen, carbon dioxide, methane, ethane, propane, natural gas, oxygen, or hydrogen. In some embodiments, the foaming agent is injected into the second composition to create a second composition with foam consistency. In some embodiments, injection of the foaming agents into the second composition occurs above ground. In some embodiments, injection of the foaming agents into the second composition occurs in the well. In some embodiments, the foaming agent is co-injected into the well along with the second composition to form a second composition with foam consistency inside the well.

In some embodiments, the second composition includes a defoaming agent. Examples of suitable defoaming agents that can be added to the second composition include, but are not limited to, mineral oil, diesel, gasoline, white oil, fatty alcohols, fatty esters, lauryl sulfate, polyalkylsiloxanes, ethylene or propylene glycol and their polymers, alkyl polyacrylates, silica powders, and alkyl alcohols such as isopropanol. In some embodiments, the defoaming agent reduces the amount of foaming that occurs during introduction of the second composition into the well. In some embodiments, the defoaming agents are included in the second composition at a concentration of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

In some embodiments, the second composition includes an emulsifier. Examples of suitable emulsifiers that can be added to the second composition include, but are not limited to diesel, gasoline, oil, mineral oil, white oil, lecithin, fatty alcohols, and fatty esters. In some embodiments, the emulsifier aids in the introduction of the second composition in the target well volume. When water-insoluble additives such as diesel and oil are in the second composition, water soluble species in the composition can remain in the aqueous fraction of the composition. When there are aqueous and non-aqueous fractions within a composition, the weight percentage of the water-soluble species is calculated based on the weight of the aqueous fraction that includes all water-soluble species dissolved in the aqueous phase. Water insoluble species such as diesel and oil are excluded from the solution weight, even when they are present as components of an emulsion. In some embodiments, an emulsifier is included in the second composition at a concentration of about 0.1 wt. % to about 50 wt. %, such as, for example, about 0.1 wt. % to about 10 wt. %, about 0.1 wt. % to about 5 wt. %, about 0.1 wt. % to about 1 wt. %, about 0.1 wt. % to about 0.5 wt. %, about 1 wt. % to about 10 wt. %, about 5 wt. % to about 50 wt. %, about 10 wt. % to about 35 wt. %, or about 10 wt. % to about 40 wt. %.

Dilute Organic Acid Composition

In the methods described in this disclosure, the first composition and second composition combine to form a third composition. In some embodiments, the combination of the first and second compositions described above forms a third composition that is a dilute organic acid composition and/or mixed organic acid/inorganic acid composition. In some embodiments, the third composition has a lower concentration of organic acid than the first composition prior to dilution with the second composition. In the methods described in this disclosure, the third composition includes the organic acid of the first composition at a concentration lower than the organic acid in the first composition.

In the methods described in this disclosure, the third composition has an organic acid concentration that allows for stimulating well production, for dissolving filter cakes, and for fracturing formations by removing acid-reactive species from the well and geologic formation. In some embodiments, the third composition has an organic acid concentration of about 25 wt. % to about 45 wt. %, about 26 wt. % to about 44 wt. %, about 27 wt. % to about 43 wt. %, about 28 wt. % to about 42 wt. %, about 29 wt. % to about 41 wt. %, about 30 wt. % to about 40 wt. %, about 31 wt. % to about 39 wt. %, about 32 wt. % to about 38 wt. %, about 33 wt. % to about 37 wt. %, about 34 wt. % to about 36 wt. %, about 30 wt. % to about 45 wt. %, about 30 wt. % to about 44 wt. %, about 30 wt. % to about 43 wt. %, about 30 wt. % to about 42 wt. %, about 30 wt. % to about 41 wt. %, about 30 wt. % to about 39 wt. %, about 30 wt. % to about 38 wt. %, about 30 wt. % to about 37 wt. %, about 30 wt. % to about 36 wt. %, or about 30 wt. % to about 35 wt. %. In some embodiments, the organic acid concentration of the third composition is about 35 wt. %.

In some embodiments, the organic acid in the third composition is MSA. In some embodiments, the concentration of MSA in the third composition is about 25 wt. % to about 45 wt. %, about 26 wt. % to about 44 wt. %, about 27 wt. % to about 43 wt. %, about 28 wt. % to about 42 wt. %, about 29 wt. % to about 41 wt. %, about 30 wt. % to about 40 wt. %, about 31 wt. % to about 39 wt. %, about 32 wt. % to about 38 wt. %, about 33 wt. % to about 37 wt. %, about 34 wt. % to about 36 wt. %, about 30 wt. % to about 45 wt. %, about 30 wt. % to about 44 wt. %, about 30 wt. % to about 43 wt. %, about 30 wt. % to about 42 wt. %, about 30 wt. % to about 41 wt. %, about 30 wt. % to about 39 wt. %, about 30 wt. % to about 38 wt. %, about 30 wt. % to about 37 wt. %, about 30 wt. % to about 36 wt. %, or about 30 wt. % to about 35 wt. %. In some embodiments, the concentration of MSA in the third composition is about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, or about 40 wt. %. In some embodiments, the concentration of MSA in the third composition is about 35 wt. %.

In some embodiments, the first composition and the second composition are added to the well at a ratio of about 1:1 to form the third composition. In some embodiments, the ratio of the first composition to the second composition is about 1:2, or in the range between 1:1 and 1:2. In some embodiments, the ratio of the first composition to the second composition is about 1:3, or in the range between 1:1 and 1:3. In some embodiments, the ratio of the first composition to the second composition is about 1:4, or in the range between 1:1 and 1:4. In some embodiments, the ratio of the first composition to the second composition is about 1:5, or in the range between 1:1 and 1:5.

In some embodiments, the combination of the first and second compositions described above forms a third composition in situ inside a well when the first and second compositions are introduced into the same or overlapping section or volume of the well. In some embodiments, the combination of the first and second compositions occurs by mixing, by diffusion, by heating of the compositions by applied heat or natural heat in the well, or by physical agitation with application of a separate fluid or gas stream into the well location where the compositions are located.

Processes for Applying the Methods and Compositions

In some embodiments, to direct the first composition and second composition to specific parts of the well, lateral section, fracture, or drill volume, a viscous fluid and other means (such as chemical, physical, or mechanical means including but not limited to a gel, a viscous liquid, a ball sealer, rock salt, flake boric acid, mechanical diverter, valve, etc.) of blocking, diverting, or plugging certain well arms, sections, extensions, and volumes are used in the process of well treatment. In this way, the stimulation, fracturing, and cleaning can be made to occur only in the sections of the well that receives both the first composition and second composition to form a third composition in situ.

In some embodiments, the first and second compositions are injected sequentially in particularly selected portions of the subterranean formation, such as fractures with low permeability in need of stimulation or fracturing. For example, the first and second compositions can be injected in the working string sequentially, where their flows can be directed by one or more flow control devices, such as bypass valves, ports, and or other tools or well devices that control the flow of the first and second compositions from the interior of the working string into fractures with low permeability.

In some embodiments, the homogeneity of the flow of the first and second compositions in the subterranean formation is verified. Upon determining that the flow of the first or second compositions in the subterranean formation is inhomogeneous, additional amounts of the first and second compositions, with viscosity modifiers, can be repeatedly injected, until homogeneous treatment is achieved. In some embodiments, upon determining that the flow of the first composition in the subterranean formation is homogeneous, a dissolvent fluid can be injected to lower the viscosity of the composition. The dissolvent fluid can include any of water, oil, brine or any other solution that can dissolve the composition, without affecting the production of hydrocarbons from the well.

In some embodiments, the well treatment methods described in this disclosure are customized to generate a homogeneous zonal coverage, even for heterogeneous wells with long lateral sections. For example, the viscosity, flowability, surface tension, and rheological properties of the first and second compositions used can be varied using additives, such as those described above. In some instances, the variability of the viscosity and other physical properties of the first and second compositions can affect the permeability into the treatment zones. The systems and processes described in this disclosure can be implemented to be simple and robust, to thereby decrease the cost of production.

In some examples, a well includes an injection system that applies a first composition to a drill volume in the subterranean zone. The subterranean zone can include a formation, multiple formations or portions of a formation. The injection system can include control trucks, pump trucks, a wellbore, a working string and other equipment. The pump trucks, the control trucks, and other related equipment are above the surface, and the wellbore, the working string, and other equipment are beneath the surface. The injection system can be deployed in any suitable environment, for example, via skid equipment, a marine vessel, sub-sea deployed equipment, or other types of equipment.

In some embodiments, the wellbore includes vertical and lateral sections. Generally, a wellbore can include lateral, vertical, slant, curved, and other types of wellbore geometries and orientations, and the treatment disclosed herein can generally be applied to any portion of a subterranean zone. The wellbore can, for example, include a casing that is cemented or otherwise secured to the wellbore wall. The wellbore can be uncased or include uncased sections. Perforations can be formed in the casing to allow fracturing fluids and/or other materials to flow into the well. Perforations can be formed using shape charges, a perforating gun, and/or other tools.

In some embodiments, the pump trucks for pumping the first composition or the second composition can include mobile vehicles, immobile installations, skids, hoses, tubes, fluid tanks or reservoirs, pumps, valves, and/or other suitable structures and equipment. The pump trucks can communicate with the control trucks, for example, by a communication link. In some instances, the pump trucks are coupled to the working string to introduce the first and second compositions into the wellbore. The working string can include coiled tubing, sectioned pipe, and/or other structures that introduce the first and second compositions through the wellbore. The working string can include flow control devices, bypass valves, ports, and or other tools or well devices that control the flow of first and second compositions from the interior of the working string into the well.

In some embodiments, the control trucks can include mobile vehicles, immobile installations, and/or other suitable structures. The control trucks can control and/or monitor the injection treatment. For example, the control trucks can include communication links that allow the control trucks to communicate with tools, sensors, and/or other devices installed in the wellbore. The control trucks can receive data from, or otherwise communicate with, a computing system that monitors one or more aspects of the treatment methods described herein.

In some embodiments, the control trucks can include communication links that allow the control trucks to communicate with the pump trucks and/or other systems. The control trucks can include an injection control system that controls the flow of the first and second compositions into the well. For example, the control trucks can monitor and/or control the concentration, density, volume, flow rate, flow pressure, location, and/or other properties of the first and second compositions introduced into the well. The well can include a fracture network with multiple fractures. Some of the fractures can be selected for acid diversion treatment. For example, the control trucks can identify that some fractures include damaged fractures. Damaged fractures can be identified based on a locally measured pressure drop that can reduce the effective permeability to oil.

In some embodiments, the injection system introduces first and second compositions to the well. The control truck controls and monitors the pump truck, which pumps diverter stages to temporarily plug the fractures with high permeability with viscous fluid containing polymers or borax or other viscosity modifiers and to allow the third composition to attack the geologic formation. In some instances, the reduction of pressure drop (real time reading) of a treated zone indicates created fractures and successful stimulation or acid fracturing treatment. Diverter can be injected until pressure drop increases, which indicates temporary blockage of the treated zone. Upon indication of a temporary blockage, a first and second compositions can be injected one after another to treat a new zone or section of a well. The characteristics of the treatment zone can be used by the control trucks to determine the features of a subsequent step.

### EXAMPLES

The following examples are intended to illustrate but not limit the compositions and methods described.

### Example 1: Evaluation of the Reactivity of MSA at Various Concentrations

A series of benchtop static dissolution tests were performed to evaluate the reactivity of methanesulfonic acid (MSA) at concentrations of 70 wt. % and 35 wt. % with limestone outcrop core samples.

Preparation of the Limestone Core Samples:

Homogenous Indiana limestone core (1.5″ diameter) was cut to 0.5″ lengths. One core sample was used for each acid reactivity test, described below. The cores were dried in an oven at 170° F. overnight to remove water and volatile components. The weights of the dried core samples were recorded.

After drying, each core was saturated in deionized water under vacuum for 12-24 hrs. The water-saturated core samples were weighed. The porosity of each core was calculated from the weight gain attributed to water saturation.

Preparation of MSA Solutions at 70 wt. %:

MSA (70 wt %) was acquired from a commercial source (E.g. Arkema or BASF).

To every 250 mL of 70 wt. % MSA solution, approximately 1 mL of a defoaming agent (D3000 L, available from Halliburton) was added to prevent excess foaming during the acid reactivity test.

Preparation of MSA Solutions at 35 wt. %:

To an aliquot of the 70 wt. % MSA solution, an equal volume of deionized water was added to dilute the 70 wt. % MSA solution to approximately 35 wt. % MSA.

To every 250 mL of 35 wt. % MSA solution, a predetermined volume of defoaming agent (1.5-5 mL) was added to prevent excess foaming during the acid reactivity test.

Acid Reactivity Test:

One water-saturated limestone core sample, as prepared above, was placed in each of two beakers. To the first beaker, 250 mL of the 70 wt. % MSA solution described above was added. To the second beaker, 250 mL of the 35 wt. % MSA solution described above was added.

The limestone core samples were submerged in the respective MSA solutions under static conditions for a duration of 5 minutes at room temperature.

The core samples were removed from the respective MSA solutions, rinsed with deionized water, submerged in deionized water and thoroughly cleaned, and rinsed again before their wet weight was measured and recorded using an analytical balance. After recording the saturated weight, the core samples were dried in an oven at 170° F. overnight to remove water and volatile components. The weight of each dried core sample was recorded and the percentage weight loss of each core was calculated and shown in Table 1 below.

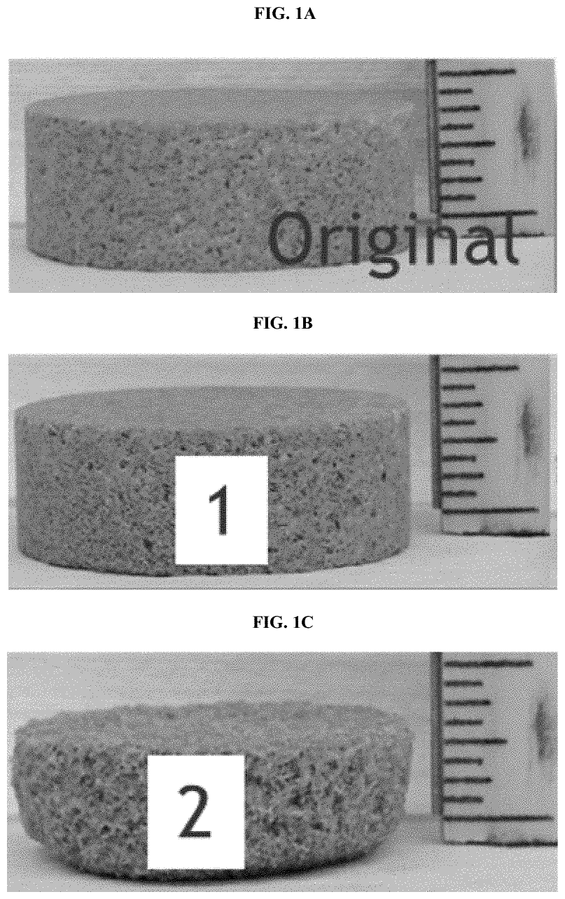

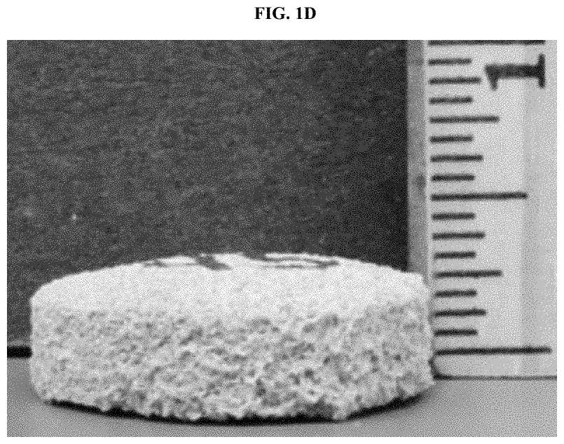

As shown in Table 1 and FIGS. 1A-1C, the untreated core sample (FIG. 1A) shows no loss of material. The core sample treated with 35 wt. % MSA (FIG. 1C) revealed a greater loss of material than the core sample treated with 70 wt. % MSA (FIG. 1B), indicating increased reactivity of the 35 wt. % MSA solution as compared to the 70 wt. % MSA solution with the limestone core sample.

### Example 2: In Situ Generation of 35 wt. % MSA Solution

An injection sequence similar to that which can be applied in the field was simulated by injecting a 70 wt. % MSA solution into a limestone core sample, followed by dilution with water.

Limestone core samples and a 70 wt. % MSA solution were prepared and measured as described in Example 1, above.

One water-saturated limestone core sample was placed in a beaker. To the beaker containing the core sample, 125 mL of 70 wt. % MSA solution was added. Reactivity of the core sample was observed for 5 minutes. During this time, few visible bubbles that would indicate an acid-base reaction between the limestone and the solution were observed.

After an exposure time of 5 minutes, i.e. after the 70 wt. % MSA solution was initially added to the beaker containing the limestone core sample, 125 mL of deionized water was added to the beaker to dilute the 70 wt. % MSA solution to approximately 35 wt. %. Vigorous bubbling of the core sample was observed, indicating rapid acid-base reaction between the limestone and the solution. After five minutes in the approximate 35 wt. % MSA solution, the limestone core sample was removed from the solution, rinsed with deionized water, submerged in deionized water and thoroughly cleaned, and rinsed again before their wet weight was measured and recorded using an analytical balance. After recording the saturated wet weight, the core sample was dried in an oven at 170° F. overnight to remove water and volatile components. The weight of the dried core sample was recorded and the percentage weight loss of each core was calculated and shown in Table 1 below. The limestone sample treated in in situ generated 35% MSA solution is shown in FIG. 1D.

TABLE 1
Calculated percentage weight loss from treatment with
70 wt. % MSA solution versus 35 wt. % MSA solution

| Sample No. | Acid Mixture | Weight Loss (%) |
|---|---|---|
| 1 | 70 wt % MSA | 0.81 |
| 2 | 35 wt % MSA | 41.1 |
| 3 | 35 wt % MSA | 53.1 |
| | (in situ) | |

1. A method for treating a well in a geologic formation comprising:
a) introducing to the well a first composition comprising about 40 wt. % to about 99.5 wt. % of an acid selected from among an alkylsulfonic acid, an arylsulfonic acid, a phosphorous acid, an alkylphosphonic acid, an arylphosphonic acid, an alkyl carboxylic acid, an aryl carboxylic acid, and combinations thereof; and
b) introducing to the well a second composition comprising water,
wherein the first and second compositions combine in the well to form a third composition comprising about 20 wt. % to about 40 wt. % of the acid.

2. The method of claim 1, wherein the third composition increases flow of hydrocarbons from the geologic formation into the well.

3. The method of claim 1, wherein the geologic formation is a carbonate formation.

4. The method of claim 3, wherein the third composition creates wormholes in the carbonate formation.

5. The method of claim 1, wherein the geologic formation is a sandstone or shale formation.

6. The method of claim 5, wherein the third composition enhances the permeability of the sandstone or shale formation.

7. The method of claim 1, wherein the acid comprises an alkylsulfonic acid.

8. The method of claim 7, wherein the acid is methanesulfonic acid.

9. The method of claim 1, wherein the first composition comprises about 65 wt. % to about 80 wt. % of the acid.

10. The method of claim 1, wherein the first composition comprises about 68 wt. % to about 72 wt. % of the acid.

11. The method of claim 10, wherein the first composition comprises about 68 wt. % to about 72 wt. % methanesulfonic acid.

12. The method of claim 1, wherein the third composition comprises about 25 wt. % to about 40 wt. % of the acid.

13. The method of claim 1, wherein the third composition comprises about 30 wt. % to about 40 wt. % of the acid.

14. The method of claim 13, wherein the third composition comprises about 10 wt. % to about 40 wt. % methanesulfonic acid.

15. The method of claim 1, wherein the well is a multilateral well comprising at least two lateral sections.

16. The method of claim 15, wherein the first composition is introduced to a lateral section of the well in which a filter cake is located.

17. The method of claim 15, wherein the first composition is introduced to more than one lateral section before the second composition is introduced to the well.

18. The method of claim 15, comprising plugging a lateral section of the well before introducing the first composition.

19. The method of claim 1, comprising introducing a diverter to the well before introducing the first composition.

20. The method of claim 1, wherein the second composition comprises brine, seawater, hydrochloric acid, formic acid, acetic acid, a carboxylic acid, an alkylsufonic acid, a metal chelating agent, a linear polymer, a crosslinked polymer, a gelling agent, an emulsifier, a foaming agent, a defoaming agent, or combinations thereof.

21. The method of claim 20, wherein the second composition comprises about 0.1 wt. % to about 32 wt. % hydrochloric acid.

22. The method of claim 20, wherein the second composition comprises about 0.1 wt. % to about 12 wt. % formic acid.

23. The method of claim 20, wherein the second composition comprises about 0.1 wt. % to about 20 wt. % acetic acid.

24. The method of claim 20, wherein the second composition comprises about 0.1 wt. % to about 20 wt. % methanesulfonic acid.

25. The method of claim 20, wherein the second composition comprises a metal chelating agent selected from the group consisting of EDTA, MGDA, GLDA, and HEDTA at a concentration of about 0.1 wt. % to about 40 wt. %.

26. The method of claim 1, wherein the first composition is a gel comprising one or more of a linear polymer, a cross-linked polymer, or a viscoelastic surfactant.

27. The method of claim 1, wherein the first composition is an emulsion comprising a diesel fuel or an oil.

28. The method of claim 1, wherein the first composition is a foam comprising a gas.

29. The method of claim 28, wherein the gas is selected from one or more of air, nitrogen, carbon dioxide, methane, ethane, propane, natural gas, oxygen, and hydrogen.

30. The method of claim 1, wherein the first composition is simultaneously introduced into the well with a gas.

31. A method for treating a multi-lateral well in a geologic formation comprising:
a) introducing to a lateral section of the multi-lateral well a first composition comprising about 68 wt. % to about 72 wt. % of an alkylsulfonic acid; and
b) introducing to the lateral section of the multi-lateral well a second composition comprising water,
wherein the first and second compositions combine in the lateral section to form a third composition comprising about 30 wt. % to about 40 wt. % of the alkylsulfonic acid.

32. The method of claim 31, wherein the acid is methanesulfonic acid.

33. The method of claim 32, wherein the third composition comprises about 30 wt. % methanesulfonic acid.

34. The method of claim 31, wherein the first composition is introduced to more than one lateral section before the second composition is introduced to the multi-lateral well.

35. The method of claim 31, comprising plugging a lateral section of the well before introducing the first composition.

36. The method of claim 31, comprising introducing a diverter to the well before introducing the first composition.

37. The method of claim 31, wherein the second composition comprises brine, seawater, hydrochloric acid, formic acid, acetic acid, a carboxylic acid, an alkylsulfonic acid, a metal chelating agent, a linear polymer, a crosslinked polymer, a gelling agent, an emulsifier, a foaming agent, a defoaming agent, or combinations thereof.

38. The method of claim 31, wherein the first composition is a gel comprising one or more of a linear polymer, a cross-linked polymer, or a viscoelastic surfactant.

39. The method of claim 31, wherein the first composition is an emulsion comprising a diesel fuel or an oil.

40. The method of claim 31, wherein the first composition is a foam comprising a gas.
